(19) United States
(12) Patent Application Publication
(10) Pub. No.: US 2008/0129886 A1
(43) Pub. Date: Jun. 5, 2008

(54) BROADCAST RECEIVING SYSTEM

(75) Inventor: Kazuhide ISHIHARA, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/947,286

(22) Filed: Nov. 29, 2007

(30) Foreign Application Priority Data
Dec. 1, 2006 (JP) 2006325395

(51) Int. Cl. H04N 5/50; H04N 5/44

(52) U.S. Cl. 348/731; 348/734; 348/E05.096; 348/E05.097

(57) ABSTRACT

A broadcast receiving system includes a plurality of remote controls and a broadcast receiving device. The plurality of remote controls each includes a plurality of keys and a control component. The control component outputs an operation signal having key identification information for identifying a key being operated out of the plurality of keys and remote control identification information for identifying a remote control being operated out of the plurality of remote controls. The broadcast receiving device receives the operation signal. The broadcast receiving device includes a channel information storage component and a channel setting component. The channel information storage component stores channel setting information specifying selectable channels according to the remote control identification information. The channel setting component sets the selectable channels based on the remote control identification information acquired from the operation signal and the channel setting information acquired from the channel information storage component.

### CROSS-REFERENCE TO RELATED APPLICATIONS

This application claims priority to Japanese Patent Application No. 2006-325395 filed on Dec. 1, 2006. The entire disclosure of Japanese Patent Application No. 2006-325395 is hereby incorporated herein by reference.

### BACKGROUND OF THE INVENTION

1. Field of the Invention

The present invention generally relates to a broadcast receiving system. More specifically, the present invention relates to a broadcast receiving system for receiving a television broadcast.

2. Background Information

Broadcast receiving devices receive television broadcasts and output the television broadcasts to monitors so that the television broadcasts are visible from outside. The number of channels that can be viewed has been increasing with an increase of popularity of digital broadcasts. Thus, users have to spend more time selecting the channels.

With some conventional television receivers, preset channel information (receivable channel information) is stored (see Japanese Laid-Open Patent Application No. 2003-298964, for example). When channels stored in the preset channel information are to be skipped, skip information is set according to the channel information. Thus, the channels for which the skip information has been set is skipped, and the channels for which no skip information has been set is received.

However, when two or more users share a single broadcast receiving device, the channels that one user wishes to watch may be different from the channels that another user wishes to watch. Also, as the number of channels that can be viewed has increased, there are now more channels broadcasting programs that include violence, obscenity, and other such scenes (hereinafter referred to as “harmful channels”). Thus, there is a growing need to control the channels that can be viewed by children, so that children will not be exposed to such programs. With the conventional broadcast receiving device, it is not easy to change settings of skip information according to which user is viewing. Therefore, the conventional broadcast receiving device is inconvenient when it comes to channel selection.

In view of the above, it will be apparent to those skilled in the art from this disclosure that there exists a need for an improved television receiving device. This invention addresses this need in the art as well as other needs, which will become apparent to those skilled in the art from this disclosure.

### SUMMARY OF THE INVENTION

The present invention was conceived in light of the above-mentioned problems. One object of the present invention is to provide a broadcast receiving system with which channel selection is more convenient.

In accordance with one aspect of the present invention, a broadcast receiving system includes a plurality of remote controls and a broadcast receiving device. The plurality of remote controls each includes a plurality of keys and a control component. The control component is configured to output an operation signal having key identification information for identifying a key being operated out of the plurality of keys and remote control identification information for identifying a remote control being operated out of the plurality of remote controls. The broadcast receiving device is configured to receive the operation signal outputted by the remote controls. The broadcast receiving device includes a channel information storage component and a channel setting component. The channel information storage component is configured to store channel setting information specifying selectable channels according to the remote control identification information. The channel setting component is configured to set the selectable channels based on the remote control identification information acquired from the operation signal and the channel setting information acquired from the channel information storage component.

With the broadcast receiving system of the present invention, it is possible to provide a broadcast receiving system with which channel selection is more convenient.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a diagram illustrating a broadcast receiving system in accordance with one embodiment of the present invention;

FIG. 2 is a block diagram illustrating a broadcast receiver in accordance with one embodiment of the present invention;

FIG. 3A is a plan view of a main remote of the broadcast receiving system illustrated in FIG. 1;

FIG. 3B is a plan view of a sub remote of the broadcast receiving system illustrated in FIG. 1;

FIG. 4 is a block diagram illustrating the main remote and the sub remote;

FIG. 5 is a block diagram illustrating a functional configuration of the broadcast receiving system illustrated in FIG. 1;

FIG. 6 is a diagram illustrating identification information;

FIG. 7 is a diagram illustrating channel setting information; and

FIG. 8 is a flowchart illustrating an operation of the broadcast receiver illustrated in FIG. 2.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

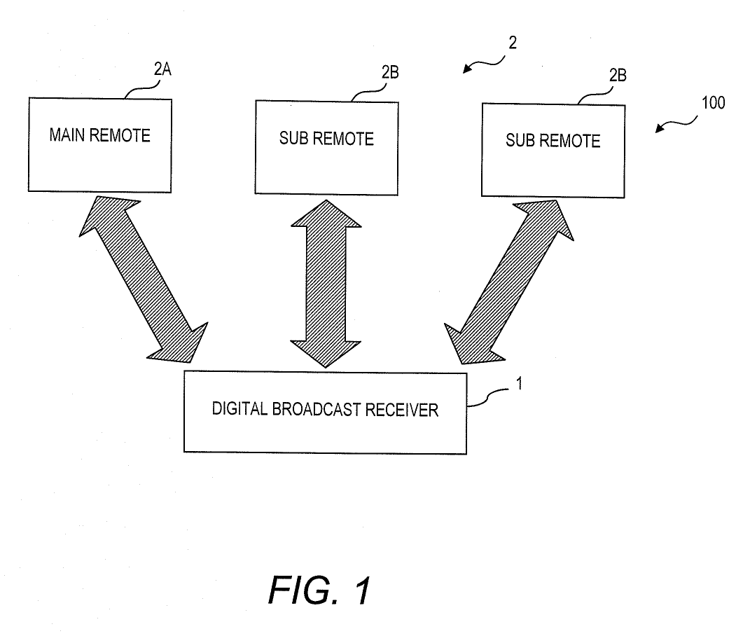

FIG. 1 is a block diagram illustrating a digital broadcast receiving system 100. The digital broadcast receiving system 100 includes a digital broadcast receiver 1 (e.g., broadcast receiving device) and a remote controller 2 (hereinafter referred to as “remote”). The digital broadcast receiver 1 is communicably connected to the remote 2 via infrared communication.

The digital broadcast receiver 1 is configured so as to receive an operation input from the user via the remote 2. The digital broadcast receiver 1 receives a television broadcast and outputs the television broadcast to display.

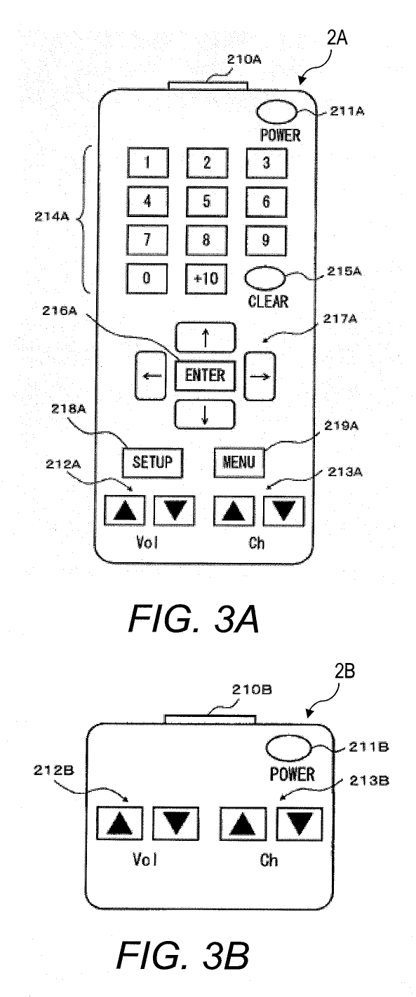

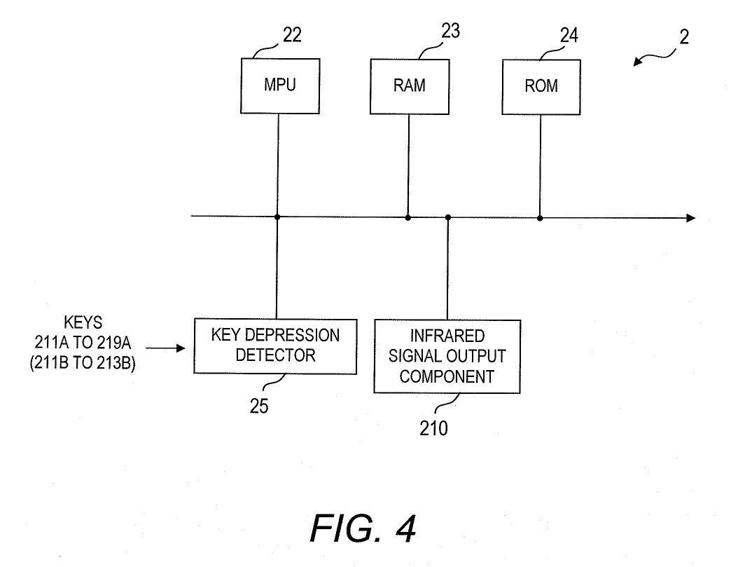

The remote 2 receives the operation input from the user. The remote 2 produces an infrared signal corresponding to the operation input. Then, the remote 2 outputs the infrared signal to the digital broadcast receiver 1. The remote 2 includes a main remote 2A and at least one sub remote 2B (two sub remotes 2B in FIG. 1). The main remote 2A (e.g., settable remote control) is kept and operated by a user (parent, etc.) who is not subject to viewing control or other functional limitations. The sub remote 2B (e.g., limited function remote control) is kept and operated by a user (child, etc.) who is subject to viewing control or other functional limitations. Specifically, the main remote 2A is configured to edit channel setting information to change selectable channels. The sub remote 2B is prevented from editing the channel setting information. The main remote 2A and the sub remote 2B have a common configuration as shown in FIGS. 3 and 4.

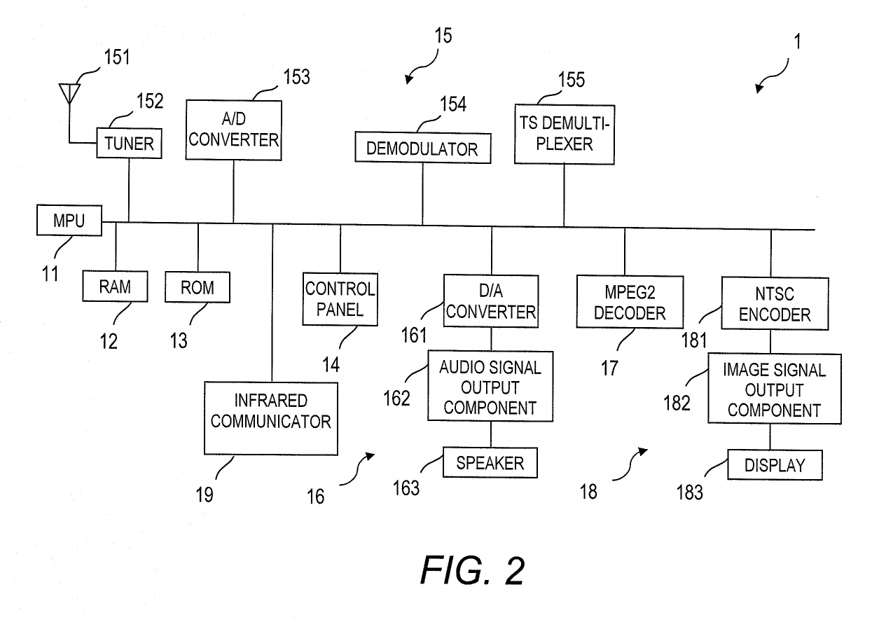

FIG. 2 is a block diagram illustrating the digital broadcast receiver 1. The digital broadcast receiver 1 includes an MPU (Micro Processing Unit) 11, a RAM (Random Access Memory) 12, a ROM (Read Only Memory) 13, a control panel 14, a reception component 15, an audio output component 16, an MPEG2 (Motion Picture Experts Group) decoder 17, an image output component 18 and an infrared communicator 19.

The MPU 11 controls an operation of the entire digital broadcast receiver 1. The RAM 12 readably and writably stores information such as audio information and video information. The ROM 13 stores a control program for operating the MPU 11, for example.

The control panel 14 is used to perform various operations, such as turning the power on and off, and changing the channel. However, the control panel 14 is configured so that operations related to various settings (channel setting, etc.) of the digital broadcast receiver 1 are prohibited. That is, the operations related to various settings of the digital broadcast receiver 1 are performed through the remote 2 (the main remote 2A). The reception component 15 receives and demodulates the television broadcast. The reception component 15 includes an antenna 151, a tuner 152, an A/D converter 153, a demodulator 154, and a TS (Transport Stream) demultiplexer 155.

The antenna 151 receives television broadcast waves. The tuner 152 tunes in a preset channel from the television broadcast waves received by the antenna 151. The A/D converter 153 converts an analog output signal of the tuner 152 into a digital signal. The demodulator 154 demodulates output information from the A/D converter 153. The TS demultiplexer 155 separates the output information demodulated by the demodulator 154 by type, and outputs audio information and video information.

The audio output component 16 outputs the audio corresponding to the television broadcast received by the reception component 15. The audio output component 16 includes a D/A converter 161, an audio signal output component 162 and a speaker 163. The D/A converter 161 converts the audio information outputted from the TS demultiplexer 155 (digital information) into an analog audio signal. The audio signal output component 162 outputs the analog audio signal to the speaker 163. The speaker 163 outputs audio corresponding to the analog audio signal.

The MPEG 2 decoder 17 decodes the video information outputted from the TS demultiplexer 155 into pre-compression video information.

The image output component 18 outputs the video information decoded by the MPEG2 decoder 17. The image output component 18 includes an NTSC (National Television Standards Committee) encoder 181, an image signal output component 182 and a display 183. The NTSC encoder 181 converts the video information decoded by the MPEG2 decoder 17 into an NTSC-format television signal. The image signal output component 182 outputs the NTSC-format television signal to the display 183. The display 183 is a display device such as an LCD (Liquid Crystal Display), PDP (Plasma Display Panel), or the like. The display 183 displays video corresponding to the NTSC-format television signal outputted from the image signal output component 182.

The infrared communicator 19 is used to handle various operations from the remote 2, such as turning the power on and off, changing the channel, and changing the settings (such as channel settings) of the digital broadcast receiver 1.

The digital broadcast receiver 1 receives the television broadcasts as follows. First, a transmitted digital broadcast wave is received by the antenna 151. When a channel is tuned in, switching of a transponder or a channel received by the tuner 152 is performed. The received digital broadcast wave is converted into digital information by the A/D converter 153, and demodulated by the demodulator 154.

The digital broadcast wave is transmitted from a transmitting side (transmitting station) as a TS (Transport Stream) packet. The TS packet includes the video information, the audio information, control information including channel information, and so forth. The video information, the audio information and the control information are separated and outputted by the TS demultiplexer 155. Then, the video information, the audio information and the control information are stored in the RAM 12. The audio information is read out from the RAM 12, and is converted into an analog audio signal by the D/A converter 161. Then, audio is outputted from the speaker 163 via the audio signal output component 162.

Also, the video information is read out from the RAM 12, and is decoded into pre-compression video information by the MPEG2 decoder 17. Then, the pre-compression video information is converted into an NTSC-format television signal by the NTSC encoder 181. Then, a video image is displayed on the display 183 via the image signal output component 182.

FIG. 3A is a plan view of the main remote 2A. FIG. 3B is a plan view of the sub remote 2B. The main remote 2A includes an infrared signal output component 210A, a power key 211A, audio volume adjustment key 212A (e.g., volume adjustment key), selection key 213A (e.g., channel selection key), a number pad 214A, a clear key 215A, an enter key 216A (e.g., setting change key), a direction key 217A (e.g., setting change key), a setup key 218A, and a menu key 219A (e.g., setting change key). The sub remote 2B includes an infrared signal output component 210B, a power key 211B, audio volume adjustment key 212B (e.g., volume adjustment key), and selection key 213B (e.g., channel selection key).

The infrared signal output components 210A and 210B produce an operation signal corresponding to a key pressed by the user. Then, the infrared signal output components 210A and 210B convert the operation signal to an infrared signal, and send the infrared signal to the digital broadcast receiver 1.

The power keys 211A and 211B are pressed to turn on the power of the digital broadcast receiver 1 or to turn off the power (that is, to put the digital broadcast receiver 1 in standby mode). The audio volume adjustment keys 212A and 212B are pressed to adjust the volume outputted from the speaker 163. Each of the audio volume adjustment keys 212A and 212B includes a volume up (VOL UP) key and a volume down (VOL DOWN) key. The volume up key is pressed to raise the volume. The volume down key is pressed to lower the volume.

The selection keys 213A and 213B are pressed to select selectable channels in a specific preset order. Each of the selection keys 213A and 213B includes a channel up (CH UP) key and a channel down (CH DOWN) key. The channel up key is pressed to change the channel number in increasing order. The channel down key is pressed to change the channel number in decreasing order. The number pad 214A includes keys assigned the numerals 0 to 10. The number pad 214A is used to input channel numbers and so forth.

The clear key 215A is pressed to cancel a channel number or the like that has been inputted. The enter key 216A is pressed to set various functions, such as the channel setting conditions of the digital broadcast receiver 1. The direction key 217A are pressed to select one of a plurality of selectable categories displayed on the display 183 during the setting of the various functions such as channel setting conditions. The direction key 217A includes four keys for moving the selection state up, down, left, or right.

The setup key 218A is pressed to display a setup screen when performing initial settings such as channel settings of the digital broadcast receiver 1. The menu key 219A is pressed to display a menu screen when setting the various functions, such as channel setting conditions, of the digital broadcast receiver 1.

FIG. 4 is a block diagram illustrating an electrical configuration of the remote 2 (an electrical configuration of each of the main remote 2A and the sub remote 2B). The remote 2 includes an MPU (Micro Processing Unit) 22 (e.g., control component), a RAM (Random Access Memory) 23, a ROM (Read Only Memory) 24, and a key depression detector 25. The MPU 22 controls the operation of the entire remote 2. The RAM 23 temporarily stores identification information and other such information.

The ROM 24 stores a control program for operating the MPU 22, for example. The key depression detector 25 detects that the power key 211 (the power key 211A or the power key 211B), the audio volume adjustment key 212 (the audio volume adjustment key 212A or the audio volume adjustment key 212B), the selection key 213 (the selection key 213A or the selection key 213B), or other keys shown in FIGS. 3A and 3B have been pressed. Then, the key depression detector 25 outputs an operation detection signal corresponding to each key to the MPU 22.

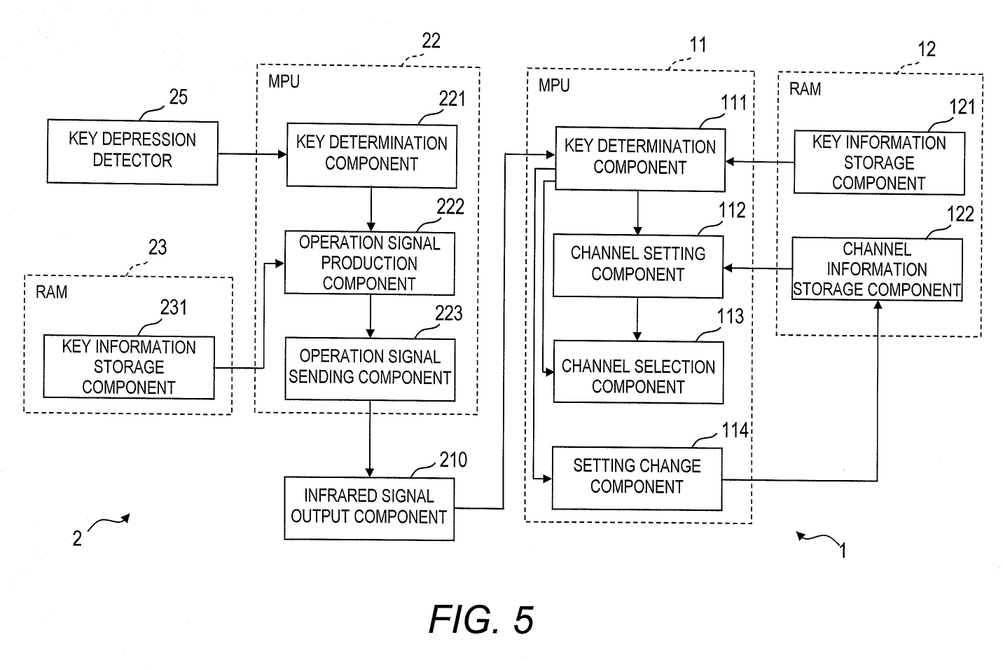

FIG. 5 is a block diagram illustrating a functional configuration of the broadcast receiving system 100. The MPU 11 of the digital broadcast receiver 1 functionally includes a key determination component 111 (e.g., operation signal receiving component), a channel setting component 112, a channel selection component 113, and a setting change component 114. The RAM 12 of the digital broadcast receiver 1

functionally includes a key information storage component 121 and a channel information storage component 122. The MPU 22 of the remote 2 functionally includes a key determination component 221, an operation signal production component 222, and an operation signal sending component 223. The RAM 23 of the remote 2 functionally includes a key information storage component 231.

The MPU 11 reads and executes a control program that has been pre-stored in the ROM 13, etc., shown in FIG. 2. Then, the MPU 11 functions as the key determination component 111, the channel setting component 112, the channel selection component 113, the setting change component 114, or another such functional component. Also, the MPU 11 causes the RAM 12 to function as the key information storage component 121, the channel information storage component 122, or another such functional component. The MPU 22 reads and executes a control program that has been pre-stored in the ROM 24, etc., shown in FIG. 4. Then, the MPU 22 functions as the key determination component 221, the operation signal production component 222, the operation signal sending component 223, or another such functional component. Also, the MPU 22 causes the RAM 23 to function as the key information storage component 231 or another such functional component.

Data stored in the RAM 12 and ROM 13 or in the RAM 23 and ROM 24 can be stored on a removable recording medium such as a hard disk, optical disk, flexible disk, CD (Compact Disk), DVD (Digital Versatile Disk), semiconductor memory, or the like. In this case, the data can be readable by a hard disk drive, optical disk drive, flexible disk drive, silicon disk drive, cassette medium reader, or other such driver.

The key information storage component 231 stores identification information. The identification information is preset for each of the keys on the remote 2. The identification information includes key identification information and remote control identification information. The key identification information is information for identifying the keys. The remote control identification information is information for identifying between the main remote 2A and the sub remote 2B. In other words, the identification information is preset differently for the main remote 2A and for the sub remote 2B.

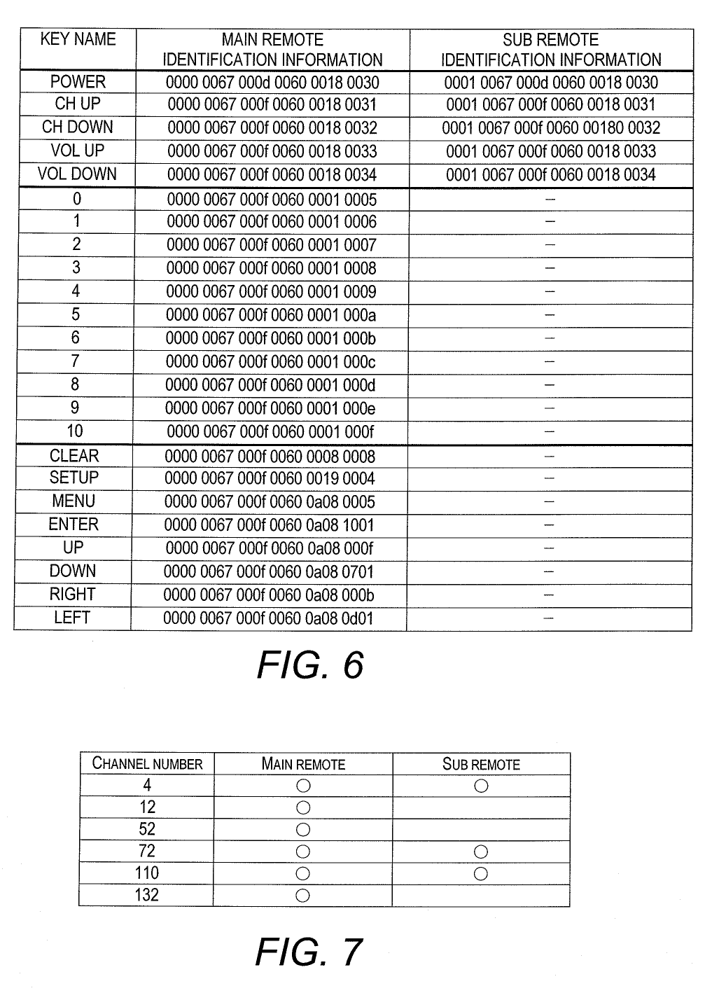

FIG. 6 is a table illustrating the identification information stored in the key information storage component 231 (and the key information storage component 121). The column on the left side of the table lists names of the keys provided to the main remote 2A and the sub remote 2B. The center column lists the remote control identification information and the key identification information for the main remote 2A. The right column lists the remote control identification information and the key identification information for the sub remote 2B.

As shown in the table, the identification information includes 24-digit identification information. The first four digits are the remote control identification information. The remaining 20 digits are the key identification information used to identify the type of key. Specifically, if the first four digits of the identification information (the remote control identification information) are “0000”, then the identification information corresponds to the main remote 2A. If the first four digits of the identification information (the remote control identification information) are “0001”, then the identification information corresponds to the sub remote 2B. The 20 digits of the information from the fifth digit in the identification information (key identification information) vary with the key so as to identify the type of key.

For example, the identification information of the power key 211A of the main remote 2A is “0000 0067 000d 0060 0018 0030”. The first four digits of the identification information “0000” indicate that the identification information corresponds to a key provided to the main remote 2A. The 20 digits from the fifth digit “0067 000d 0060 0018 0030” indicate that the type of key is a power key.

As shown in FIG. 5, the key determination component 221 uses the key depression detector 25 to ascertain that the user has pressed the power key 211A or 211B, an audio volume adjustment key 212A or 212B, or the like. Then, the key determination component 221 identifies which of the plurality of keys has been pressed.

The operation signal production component 222 reads from the key information storage component 231 the identification information corresponding to the key determined by the key determination component 221 to have been pressed. Then, the operation signal production component 222 uses the identification information to produce the operation signal. Specifically, the operation signal production component 222 of the main remote 2A reads the identification information located in the center column of the identification information according to the key determined to be pressed. The operation signal production component 222 of the sub remote 2B reads the identification information located in the right column of the identification information according to the key determined to be pressed. Then, the operation signal production component 222 produce the operation signal according to the remote 2 which is operated and the key determined to be pressed.

The operation signal sending component 223 sends the operation signal produced by the operation signal production component 222 to the digital broadcast receiver 1 after conversion into an infrared communication signal by the infrared signal output component 210 (the infrared signal output component 210A or the infrared signal output component 210B).

The key information storage component 121 is similar to the key information storage component 231 of the remote 2 in that it stores the identification information shown in FIG. 6. The identification information includes the key identification information and the remote control identification information. The key identification information is information with which the keys can be identified. Also, the remote control identification information is preset differently for the main remote 2A and for the sub remote 2B.

The channel information storage component 122 stores channel setting information specifying selectable channels. Specifically, the channel information storage component 122 stores the channel setting information according to remote control identification information. The remote control identification information is information allowing the main remote 2A and the sub remote 2B to be identified.

FIG. 7 is a table illustrating the channel setting information stored in the channel information storage component 122. The column on the left side of the table lists channel numbers of channels that can be received through the reception component 15. The center column lists channel setting information specifying channels that can be selected by the main remote 2A. The right column lists channel setting information specifying channels that can be selected by the sub remote 2B. The circles in the table indicate that the channel can be selected.

Specifically, all six of the receivable channels are set to be selectable with the main remote 2A. On the other hand, only three of the receivable channels, namely, channels 4, 72, and 110, are set to be selectable with the sub remote 2B.

The key determination component 111 determines whether or not the operation signal has been received from the remote 2 (the operation signal sending component 223) via the infrared communicator 19. Specifically, the key determination component 111 determines the type of the remote 2 (the main remote 2A or the sub remote 2B) and the type of key. More specifically, the key determination component 111 refers to the key information storage component 121. Then, the key determination component 111 determines whether the operation signal is from the main remote 2A or the sub remote 2B based on the received operation signal. Furthermore, the key determination component 111 determines which key the operation signal corresponds to out of the keys provided to the remote 2.

If the key determination component 111 determines that the operation signal has been received, then the channel setting component 112 reads from the channel information storage component 122 the channel setting information corresponding to the remote control identification information included in the received operation signal. Furthermore, the channel setting component 112 sets the selectable channels based on the channel setting information.

If the operation signal corresponding to the main remote 2A is received by the key determination component 111, then the channel setting component 112 sets all six of the receivable channels to be selectable. If the operation signal corresponding to the sub remote 2B is received by the key determination component 111, then the channel setting component 112 sets only three of the six receivable channels, namely, channel numbers “4”, “72”, and “110”, to be selectable.

If the key determination component 111 determines that the operation signal corresponding to a selection key 213 has been received, then the channel selection component 113 selects, in a specific preset order, the selectable channels set by the channel setting component 112. More specifically, when it is determined that the operation signal corresponding to the channel down key out of the selection keys 213A and 213B shown in FIG. 3 has been received, the selectable channels set by the channel setting component 112 are selected in decreasing order. When it is determined that the operation signal corresponding to the channel up key out of the selection keys 213A and 213B shown in FIG. 3 has been received, the selectable channels set by the channel setting component 112 are selected in increasing order.

For example, if it is determined that the operation signal corresponding to the channel up key of the selection key 213A on the main remote 2A has been received when channel number “72” shown in FIG. 7 is currently selected, then channel number “110” is selected. If it is determined that the operation signal corresponding to the channel down key of the selection key 213A on the main remote 2A has been received when channel number “72” shown in FIG. 7 is currently selected, then channel number “52” is selected.

Also, for example, if it is determined that the operation signal corresponding to the channel up key of the selection key 213B on the sub remote 2B has been received when channel number “72” shown in FIG. 7 is currently selected, then channel number “110” is selected. If it is determined that the operation signal corresponding to the channel down key of the selection key 213B on the sub remote 2B has been received when channel number “72” shown in FIG. 7 is currently selected, then channel number “4” is selected.

If the key determination component 111 determines that the operation signal corresponding to the menu key 219A on the main remote 2A has been received, then the setting change component 114 changes the channel setting information stored in the channel information storage component 122 based on the received operation signal.

More specifically, if it is determined that the operation signal corresponding to the menu key 219A on the main remote 2A has been received, then the setting change component 114 displays the channel setting information shown in FIG. 7 on the display 183. If the key determination component 111 determines that the operation signal corresponding to one of the direction key 217A on the main remote 2A has been received, then position of a cell in a selected state is moved in the direction indicated by the direction key 217A. Furthermore, if the key determination component 111 determines that the operation signal corresponding to the enter key 216A on the main remote 2A has been received, then the channel selection of the channel corresponding to the position of the cell in the selected state is alternately set to be enabled or disabled.

For example, if the key determination component 111 determines that the operation signal corresponding to the down key of the direction key 217A on the main remote 2A has been received, then the position of the cell in the selected state is moved downward. Specifically, if the key determination component 111 determines that the operation signal corresponding to the down key of the direction key 217A on the main remote 2A has been received when a cell setting a channel selection for channel number “4” and sub remote 2B is in the selected state, then a cell setting the channel selection for channel number “12” and sub remote 2B is changed to the selected state. In this state, for example, if the key determination component 111 determines that the operation signal corresponding to the enter key 216A on the main remote 2A has been received, then the setting change component 114 changes the information about whether or not channel number “12” can be selected with the sub remote 2B from a selection disabled state (a state in which circle is not displayed) to a selection enabled state (a state in which a circle is displayed). Furthermore, in this state, for example, if the key determination component 111 determines that the operation signal corresponding to the enter key 216A on the main remote 2A has been received again, then the setting change component 114 changes the information about whether or not channel number “12” can be selected with the sub remote 2B from the selection enabled state (a state in which circle is displayed) to the selection disabled state (a state in which a circle not is displayed).

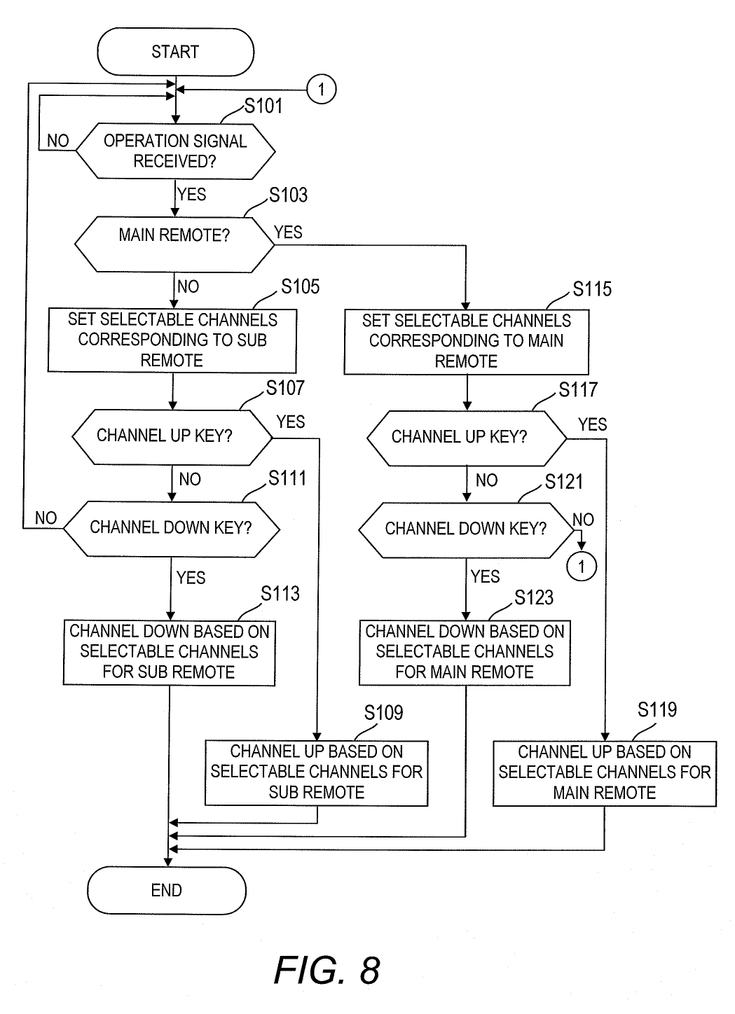

FIG. 8 is a flowchart illustrating an operation of the digital broadcast receiver 1. The channel setting information specifying selectable channels according to the remote control identification information is stored ahead of time in the channel information storage component 122. First, the key determination component 111 determines whether or not the operation signal has been received (S101).

If it is determined that the operation signal has not been acquired (No in S101), then the processing enters a standby state. If it is determined that the operation signal has been acquired (Yes in S101), then the key determination component 111 refers to the key information storage component 121 to determine whether or not the signal is the operation signal from the main remote 2A (S103). If the operation signal is determined to be from the main remote 2A (Yes in S103), then the processing proceeds to step S115. If it is determined that the operation signal is not from the main remote 2A (if the operation signal is from the sub remote 2B) (No in S103), then the selectable channels corresponding to the sub remote 2B are set by the channel setting component 112 (S105).

Furthermore, the key determination component 111 determines whether or not the operation signal corresponding to the channel up key of the selection key 213B on the sub remote 2B has been received (S107). If it is determined that the operation signal corresponding to the channel up key has been received (Yes in S107), then the next channel after the currently selected channel (a lower channel in the table shown in FIG. 7) out of the selectable channels is selected by the channel selection component 113 (S109). Then, the processing is concluded. If it is determined that the operation signal corresponding to the channel up key has not been received (No in S107), then the key determination component 111 determines whether or not the operation signal corresponding to the channel down key of the selection key 213B on the sub remote 2B has been received (S111).

If it is determined that the operation signal corresponding to the channel down key has not be received (No in S111), then the processing returns to step S101 and the processing from step S101 is repeated. If it is determined that the operation signal corresponding to the channel down key has been received (Yes in S111), then the channel ahead of the currently selected channel (an upper channel in the table shown in FIG. 7) out of the selectable channels is selected by the channel selection component 113 (S113). Then, the processing is concluded.

If the answer is Yes in step S103, then the channel setting component 112 sets selectable channels corresponding to the main remote 2A (S115). Furthermore, the key determination component 111 determines whether or not the operation signal corresponding to the channel up key has been received (S117). If it is determined that the operation signal corresponding to the channel up key has been received (Yes in S117), then the next channel after the currently selected channel (a lower channel in the table shown in FIG. 7) out of the selectable channels is selected by the channel selection component 113 (S119). Then, the processing is concluded. If it is determined that the operation signal corresponding to the channel up key has not been received (No in S117), then the key determination component 111 determines whether or not the operation signal corresponding to the channel down key of the selection key 213A on the main remote 2A has been received (S121).

If it is determined that the operation signal corresponding to the channel down key has not be received (No in S121), then the processing returns to step S101 and the processing from step S101 is repeated. If it is determined that the operation signal corresponding to the channel down key has been received (Yes in S121), then the channel ahead of the currently selected channel (an upper channel in the table shown in FIG. 7) out of the selectable channels is selected by the channel selection component 113 (S123). Then, the processing is concluded.

With the digital broadcast receiving system 100, when one of the pluralities of keys on the main remote 2A and the sub remote 2B is pressed, the remote control identification information for identifying between the main remote 2A and the sub remote 2B is sent as the operation signal to the digital broadcast receiver 1. Then, the digital broadcast receiver 1 (the key determination component 111) determines whether or not the operation signal has been received from the main remote 2A or the sub remote 2B. If it is determined that the operation signal has been received, then the channel setting information corresponding to the remote control identification information included in the received operation signal is read out. Then, the selectable channels are set based on the channel setting information. Therefore, channel selection becomes more convenient.

Specifically, the selectable channels are set based on the channel setting information corresponding to the remote control identification information. Thus, the user can set the selectable channels for each of the main remote 2A and the sub remote 2B. Therefore, only the channels that the user wants to watch can be selected by specifying a user for each of the main remote 2A and the sub remote 2B.

Also, the selectable channels are set based on the channel setting information corresponding to the remote control identification information. Therefore, viewing control can be easily accomplished. Specifically, it is possible to exclude harmful channels from the selectable channels selected with the sub remote 2B which is used by a child, for example.

Furthermore, when it is determined that the operation signal corresponding to the selection key 213A or 213B on one of the remotes 2A and 2B has been received, the selectable channels are selected in a specific preset order. Therefore, the channel selection becomes more convenient.

Specifically, when the user presses a selection key 213A or 213B, the selectable channels are selected in the specific preset order. Therefore, the channel selection can be made more convenient by suitably setting the selectable channels.

In addition, the sub remote 2B has only three types of key, namely, the power key 211B, the volume adjustment key 212B and the selection key 213B. Therefore, viewing control is performed even more easily.

Specifically, there are only three operations that can be performed through the sub remote 2B, namely, turning on the power to the digital broadcast receiver 1, raising or lowering the audio volume outputted from the digital broadcast receiver 1, and selecting the selectable channels. The viewing control is performed even more easily by having children or others who are to be subject to viewing control use the sub remote 2B.

Also, when it is determined that the operation signal has been received corresponding to a setting change key (here, the enter key 216A, the direction key 217A, and the menu key 219A) on the main remote 2A, the channel setting information is changed based on the received operation signal. Thus, the viewing control is performed more reliably.

Specifically, since the channel setting information is changed through the main remote 2A, which is a remote control other than the sub remote 2B, the viewing control is performed more reliably by having only parents or others who are setting the viewing control use the main remote 2A.

The broadcast receiving system 100 can includes only two remotes 2 (one main remote 2A and one sub remote 2B), or include four or more remotes 2.

The broadcast receiver 1 can be any type of broadcast receiving device that receives television broadcasts and outputs the television broadcasts to the display 183 so that the television broadcasts are visible from outside. For instance, the broadcast receiving device can be a device that receives analog broadcasts or both analog and digital broadcasts.

The display 183 can be configured as a device that is separate from the digital broadcast receiver 1. For example, the display 183 can be a monitor provided to a personal computer or the like.

In this embodiment, the setting change key includes the enter key 216A, the direction key 217A, and the menu key 219A. However, the setting change key can instead include one or more keys from among the enter key 216A, the direction key 217A, and the menu key 219A, or can include other keys.

In this embodiment, there are two types of remote control identification information, namely, one type corresponding to the main remote 2A and one to the sub remote 2B. However, there can be three or more types of the remote control identification information. The more types of the remote control identification information there are, the more precisely the channel setting information can be set. For example, if the remote control identification information is set for every member of a family, then the channel setting information can be set corresponding to every member of the family.

In this embodiment, the channel selection component 113 selected the selectable channels in a specific preset order. However, the order in which the selectable channels are selected can be set. Specifically, a selection order setting component can be provided for setting the order in which the selectable channels are to be set based on operation input from the user. Then, the channel selection component 113 selects the selectable channels in the order set by the selection order setting component. The system becomes more convenient in this case.

In this embodiment, the sub remote 2B includes the power key 211B, the audio volume adjustment key 212B, and the selection key 213B. However, the sub remote 2B can include one or more keys other than the setting change key, such as a number pad, which are pressed to input channel numbers and so forth.

The key information storage component 231 of the main remote 2A and the key information storage component 231 of the sub remote 2B do not necessarily store the identification information shown in FIG. 6. The key information storage component 231 of the main remote 2A can store only the identification information related to the main remote 2A (e.g., the left and center columns of the identification information shown in FIG. 6). The key information storage component 231 of the main remote 2B can store only the identification information related to the main remote 2B (e.g., the left and right columns of the identification information shown in FIG. 6).

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A broadcast receiving system comprising:
a plurality of remote controls each including
a plurality of keys, and
a control component being configured to output an operation signal having key identification information for identifying a key being operated out of the plurality of keys and remote control identification information for identifying a remote control being operated out of the plurality of remote controls; and
a broadcast receiving device configured to receive the operation signal outputted by the remote controls, the broadcast receiving device including
a channel information storage component configured to store channel setting information specifying selectable channels according to the remote control identification information;
a channel setting component configured to set the selectable channels based on the remote control identification information acquired from the operation signal and the channel setting information acquired from the channel information storage component.

2. The broadcast receiving system according to claim 1, wherein
the broadcast receiving device further includes a key determination component being configured to determine whether or not the operation signal is received, and
the channel setting component is further configured to acquire the channel setting information corresponding to the remote control identification information when the key determination component determines that the operation signal is received.

3. The broadcast receiving system according to claim 2, wherein
the keys of the remote controls include a channel selection key for selecting the selectable channels, and
the broadcast receiving device further includes a channel selection component being configured to select the selectable channels in a specific order when the key determination component determines that the operation signal having the key identification information corresponding to the channel selection key is received.

4. The broadcast receiving system according to claim 1, wherein
the remote controls include a main remote control being configured to edit the channel setting information stored in the channel information storage component to change the selectable channels, and a sub remote control being configured to be prevented from editing the store channel setting information.

5. The broadcast receiving system according to claim 4, wherein
the keys associated with the sub remote control include a power key for turning on and off the power of the broadcast receiving device, a volume adjustment key for adjusting audio volume of the broadcast receiving device and a channel selection key for selecting the selectable channels.

6. The broadcast receiving system according to claim 2, wherein
the keys associated with the main remote control include a setting change key for editing the channel setting information stored in the channel information storage component, and
the broadcast receiving device further includes a setting change component being configured to change the channel setting information stored in the channel information storage component when the key determination component determines that the operation signal having the key identification information corresponding to the setting change key is received.

7. The broadcast receiving system according to claim 2, wherein
the remote controls include a main remote control being configured to edit the channel setting information stored in the channel information storage component to change the selectable channels, and a sub remote control being configured to be prevented from editing the store channel setting information.

8. The broadcast receiving system according to claim 7, wherein
the keys associated with the sub remote control include a power key for turning on and off the power of the broadcast receiving device, a volume adjustment key for adjusting audio volume of the broadcast receiving device and a channel selection key for selecting the selectable channels.

9. The broadcast receiving system according to claim 8, wherein
the keys associated with the main remote control include a setting change key for editing the channel setting information stored in the channel information storage component, and
the broadcast receiving device further includes a setting change component being configured to change the channel setting information stored in the channel information storage component when the key determination component determines that the operation signal having the key identification information corresponding to the setting change key is received.

10. A broadcast receiving device comprising:
an operation signal receiving component configured to receive operation signals outputted by a plurality of remote controls, the operation signals having key identification information for identifying a key operation being performed from among a plurality of keys provided to each of the remote controls, and remote control identification information for identifying which of the remote controls is being operated;
a channel information storage component configured to store channel setting information specifying selectable channels according to the remote control identification information; and
a channel setting component configured to set the selectable channels based on the remote control identification information acquired from the operation signals and the channel setting information acquired from the channel information storage component.

11. A channel setting method for a broadcast receiving device, comprising:
acquiring operation signals outputted by a plurality of remote controls, the operation signals having key identification information for identifying a key operation being performed from among a plurality of keys provided to each of the remote controls, and remote control identification information for identifying which of the remote controls is being operated;
acquiring channel setting information specifying selectable channels according to the remote control identification information; and
setting the selectable channels based on the remote control identification information and the channel setting information.
